(19) United States
(12) Patent Application Publication
(10) Pub. No.: US 2002/0124087 A1
(43) Pub. Date: Sep. 5, 2002

(54) System and method for providing dynamic service using front-end

(76) Inventors: Kano Asai, Tokyo (JP); Toru Egashira, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/083,465

(22) Filed: Feb. 27, 2002

(30) Foreign Application Priority Data
Mar. 1, 2001 (JP) 056872/2001

(51) Int. Cl. G06F 15/173; G06F 15/16

(52) U.S. Cl. 709/226; 709/224

(57) ABSTRACT

There is provided a method and system for providing services, in which front-ends are efficiently controlled on the basis of response times of services to cope with fluctuations in network traffic, and front-end application environment providers can charge front-end users for the use of front-ends on utilization basis. The system comprises a server for processing service tasks in response to service request from a client, and delivering service to the client, a means for measuring service response time from when the client requests the server for service to when the server delivers the service to the client, a means for judging whether or not the service response time is equal to or more than a setting value, a means for creating a front-end to process the service tasks of the server and perform the service delivery in whole or in part when the service response time is equal to or more than the setting value, and a means for having the front-end process the service tasks and perform the service delivery in whole or in part as proxy for the server.

### FIELD OF THE INVENTION

The present invention relates to a system and method for providing dynamic service using front-ends in communication networks managed by telecommunications carriers, in which when a user enjoys a service offered by a service provider via the communication network, the service is provided from a communication device being an interface between the user and the communication network according to response time of the service measured at the communication device.

### BACKGROUND OF THE INVENTION

Conventionally, service providing methods of this type have been employed to improve responsiveness of services so that service quality is not degraded by the fluctuation in network traffic or the number of users as is described in, for example, Tomohiro Igakura, Toru Egashira and Yoshiaki Kiriha “Management Middleware for Application Front-end on Active Networks”, IEICE (Institute of Electronics, Information and Communication Engineers) Technical Report: Telecommunication Management, Vol. 99, No. 430, pp13-18, TM99-32, Nov. 15, 1999.

FIG. 1 is a functional diagram showing a configuration for implementing a conventional method of providing dynamic services.

Referring to FIG. 1, the conventional dynamic service providing system comprises a front-end 701, a server 702, a client 703 and a front-end management middleware 704. The front-end management middleware 704 includes a look-up function part 705, a probe function part 706, a front-end controller 707, a server controller 708, and a communication subsystem 709. The front-end 701, server 702, and client 703 operate with the functional components of the front-end management middleware 704.

The client 703 is a program for connecting to a designated communication device in a communication network that is comprised of communication devices and computers, and receiving a service provided from a server on a computer at the other end. Examples of the client 703 include a Web browser for browsing data written in HTML (Hyper Text Markup Language) and an E-mail client for reading e-mail. Incidentally, while FIG. 1 only shows one client, there are practically plural clients connected to the front-end management middleware 704.

The server 702 is also a program, which is executed on the computer to provide clients with a wide variety of services through the network. The server 702 may be an HTTP (Hypertext Transfer Protocol) server that responds to a request sent from a Web browser by using HTTP, or a POP (Post Office Protocol) server that delivers e-mail requested by a client using POP. Incidentally, while FIG. 1 only shows one server, there are practically plural servers connected to the front-end management middleware 704.

In addition, the front-end 701 is a program, which is placed in between the server 701 and client 703 to take over the service processing function of the server 702 in whole or in part. Incidentally, while FIG. 1 only shows one front-end, there are practically plural front-ends connected to the front-end management middleware 704.

In the following, each component of the front-end management middleware 704 will be described.

The look-up function part 705 searches for a front-end for use based on the name of service requested by the client 703. The front-end is located in such manner as selecting the nearest front-end to the client 703, the least loaded front-end at the search time, or selecting a front-end from among plural front-ends in sequence by round robin.

The probe function part 706, if needed, is present in between the front-end 701 and client 703 to retrieve a variety of information. The information includes the volume of traffic between the front-end 701 and client 703, and the amount of memory resources consumed by the front-end 701.

The front-end controller 707 provides a function for implementing intercommunication between the front-end 701 and server 702 (hereinafter referred to as a basic communication function), a function for controlling the front-end 701 by request from the server controller 708 or the front-end 701 itself, and a function for informing the server controller 708 of changes in the state of the front-end 701 such as abnormal termination. The front-end control involves such operations as creation, halt, activation and termination of the front-end, and the same applies to the following description.

The server controller 708 provides a function for controlling service programs including the front-end 701, the basic communication function, a function for managing front-ends for the same operation as a group, a function for managing the information collected by the probe function part 706 as statistical information, a function for sending the front-end control request from the server 702 to the front-end controller 707, and a function for informing the server 702 of changes in the state of the front-end 701 sent from the front-end controller 707.

The communication subsystem 709 implements intercommunication among the look-up function part 705, probe function part 706, front-end controller 707, and server controller 708.

Besides, monitoring of service performance such as service response time has been performed in an effort to improve a quality of services for users.

For example, there is described a service performance monitoring system, which facilitates modifications of a monitoring program by implementing the monitoring program on a front-end between a client and a server, in Tomohiro Igakura, Kano Asai, Toru Egashira and Yoshiaki Kiriha “Front-End-Based Service Performance Monitoring”, IEICE Technical Report: Telecommunication Management, Vol. 100, No. 55, pp27-32, TM2000-5, May 18, 2000.

The above-mentioned conventional techniques, however, have some problems. One problem with the conventional techniques is that service providers cannot use front-ends efficiently, and it is practically impossible for front-end application environment providers to charge the service providers for the use of front-ends on utilization basis. This is because the conventional techniques do not have valid control standards for efficiently creating necessary front-ends to provide services requested from the clients, and thus possibly causing excess front-ends.

Another problem is that the safety of programs, which are executed on computers and communication devices connected to a communication network, is not assured. Namely, when controlling front-ends, the server 702 may execute a front-end that affects other programs executed on computers and communication devices connected to the same communication network.

A further problem is that the client 703 needs to implement the look-up function part 705 provided by the front-end management middleware 704 in order to search for a front-end for use from among plural front-ends on a communication network managed by a telecommunications carrier.

### SUMMARY OF THE INVENTION

It is therefore an object of the present invention to provide a system and method for providing services, in which front-ends are efficiently controlled on the basis of response times of services to cope with fluctuations in network traffic, and front-end application environment providers can charge front-end users for the use of front-ends on utilization basis.

It is another object of the present invention to prevent a program executed as the front-end from affecting other programs run on computers or communication devices connected to the same communication network, and secure the programs.

It is another object of the present invention to process service request from clients on the front-ends without making changes in the clients.

In accordance with the present invention, to achieve the above object, there is provided a service providing method comprising the steps of measuring response time of service for a client; performing front-end control according to the measured response time; and managing charging information derived from the amount of resources consumed by the front-ends. More specifically, a front-end application environment provider possesses, on a communication device connected to a communication network managed by the front-end application environment provider, a means for measuring response times of services requested by clients and controlling front-ends based on the response times, and a means for managing charging information derived from resource consumption by the front-ends Besides, the method is characterized in that a service program executed as the front-end on the communication device is controlled by a computer managed by the telecommunications carrier. To be concrete, service providers register their service programs on the computer by using a service program registration means provided by the telecommunications carrier.

Furthermore, the method is also characterized in that the destination of service request from the client is identified at the communication device managed by the telecommunications carrier. To be more precise, the communication device identifies the destination of service request sent from the client to the server managed by the service provider when the service request goes through the communication device.

In other words, in accordance with the present invention, response time of service requested by the client is measured at the communication device connected to the client. By using a standard value of service response time previously settled between the telecommunications carrier and service provider, the front-end is created on the basis of the measured response time, and thereby the service is provided from the front-end to the client. Thus, it is possible to shift service tasks that place loads on the server to the front-end. In addition, the front-end can be utilized efficiently according to the demand for services.

Moreover, in accordance with the present invention, only service programs, which are specified in an agreement between the telecommunications carrier and service provider and identified as having no influence on other programs, can be registered on the computer managed by the telecommunications carrier. Consequently, front-end control is performed only by the telecommunications carrier in charge of the computer where the service programs are registered.

Furthermore, in accordance with the present invention, the communication device identifies the destination of service request from the client to the server when the service request goes through the communication device, and processes service tasks for the service request on their own front-end. Thus, the client can utilize the front-end without changing their software.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a configuration of conventional method for providing dynamic services;

FIG. 2 is a block diagram showing a configuration of a system for providing services using front-ends according to an embodiment of the present invention;

FIG. 3 is a functional block diagram showing a configuration of a front-end controller and front-end shown in FIG. 2;

FIG. 4 is a functional block diagram showing a configuration of a service controller and service management part shown in FIG. 2;

FIG. 5 is a block diagram illustrating a system for providing services using front-ends and distribution of functions according to an embodiment of the present invention;

FIG. 6 is a flowchart showing the operation for providing a service using a front-end according to an embodiment of the present invention; and

FIG. 7 is a flowchart showing details of step 503 in the operation of FIG. 6.

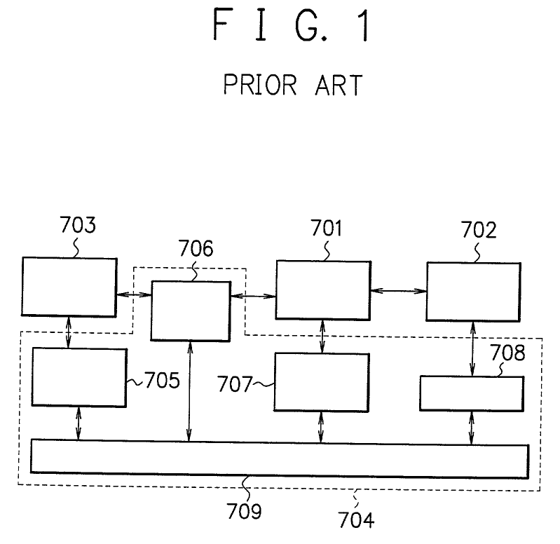

### DESCRIPTION OF THE PREFERRED EMBODIMENT

Referring now to the drawings, a description of a preferred embodiment of the present invention will be given in detail.

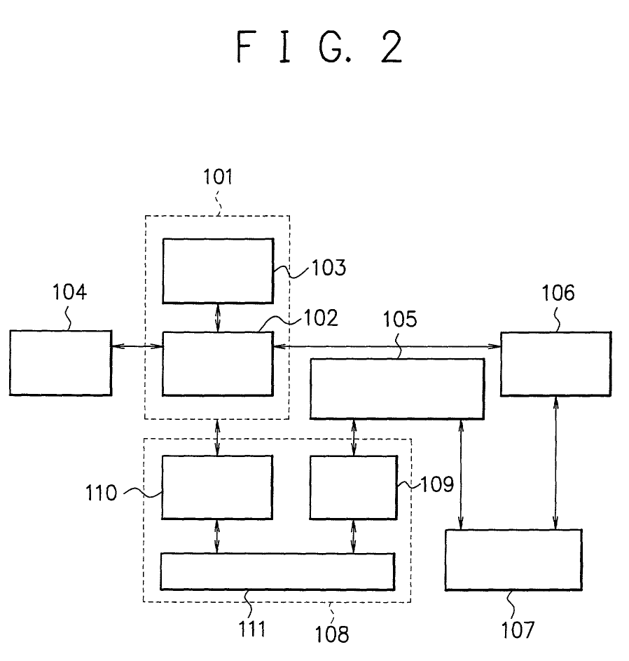

FIG. 2 is a block diagram showing a front-end-based service providing system according to an embodiment of the present invention. In FIG. 2, the system comprises a front-end 101, a client 104, a service management part 105, a server 106, a service registration means 107, and a front-end management means 108. The front-end 101 includes an probe front-end 102 for measuring response time (a period of time from when the client requests the server for service to when the server delivers the service to the client) of service requested from the client 104 to the server 106 and a variety of information, and a service front-end 103 for providing the same service as that the server 106 offers when the response time of service measured by the probe front-end 102 exceeds a predetermined standard value of service response time. The variety of information measured by the probe front-end 102 includes, for example, the volume of traffic between the service front-end 103 and client 104, and the amount of resources consumed by the service front-end 103.

Incidentally, while only one front-end 101, client 104 and server 106 are seen in FIG. 2, there is practically more than one of them comprised in the system.

The service management part 105 controls service programs executed at the service front-end 103, and charges for the use of front-ends according to the utilization. The service registration means 107 makes it possible to register service programs from the server 106 on the service management part 105.

The front-end management means 108 includes a service controller 109 for giving instructions for controlling the probe front-end 102 and service front-end 103 on the basis of service response times, a front-end controller 110 for practically controlling the probe front-end 102 and service front-end 103 on the basis of the instructions from the service controller 109, and a communication subsystem 111 for implementing intercommunication between the service controller 109 and front-end controller 110.

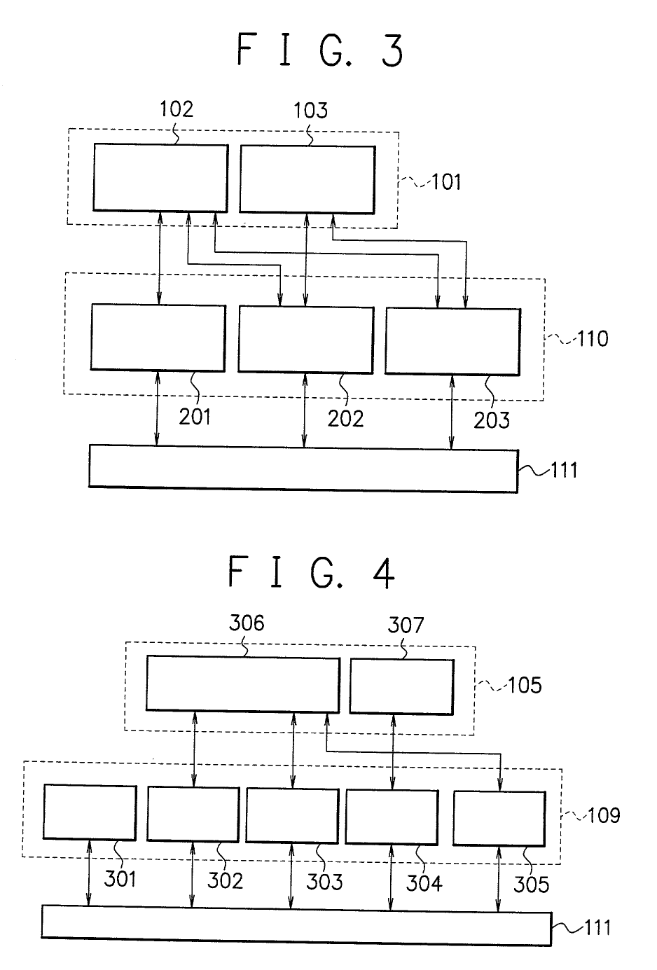

As shown in FIG. 3, the front-end controller 110 is provided with a service performance monitoring function 201, a front-end control function 202 and a basic communication function 203. The service performance monitoring function 201 measures response times of services offered to the client 104, and collects such information as traffic between the service front-end 103 and client 104 as well as the amount of resources consumed by the service front-end 103 (the amount of computer resource). The front-end control function 202 practically controls the front-ends based on instructions on front-end control from the service controller 109. The basic communication function 203 implements intercommunication between the front-end 101 (probe front-end 102 and service front-end 103) and the service management part 105.

As can be seen in FIG. 4, the service management part 105 is provided with a service program management function 306 and a charging information management function 307. The service program management function 306 stores service programs that the server 106 has registered by using the service registration means 107. The charging information management function 307 manages charging information based on statistical information about traffic between the service front-end 103 and client 104, the amount of resources consumed by the service front-end 103 and the like.

The service controller 109 is provided with a policy management function 301, a program management function 302, a front-end control instruction function 303, a statistical information management function 304, and a basic communication function 305. The policy management function 301 manages standards of front-end control predetermined by a telecommunications carrier, and makes front-end control request to the front-end control instruction function 303 based on the result of comparison between the service response time informed by the service performance monitoring function 201 and the standards of front-end control. The program management function 302 implements the service program management function 306, and manages the service front-ends that perform the same process as a group. The front-end control instruction function 303 gives instructions on front-end control to the front-end control function 202 by request from the policy management function 301. The statistical information management function 304 manages such information as traffic between the service front-end 103 and client 104 as well as the amount of resources consumed by the service front-end 103 monitored by the service performance monitoring function 201 as statistical information in order to control front-ends efficiently and supply the charging information management function 307 with the information. The basic communication function 305 implements intercommunication between the front-ends 101 (probe front-ends 102 and service front-ends 103) and the service program management function 306.

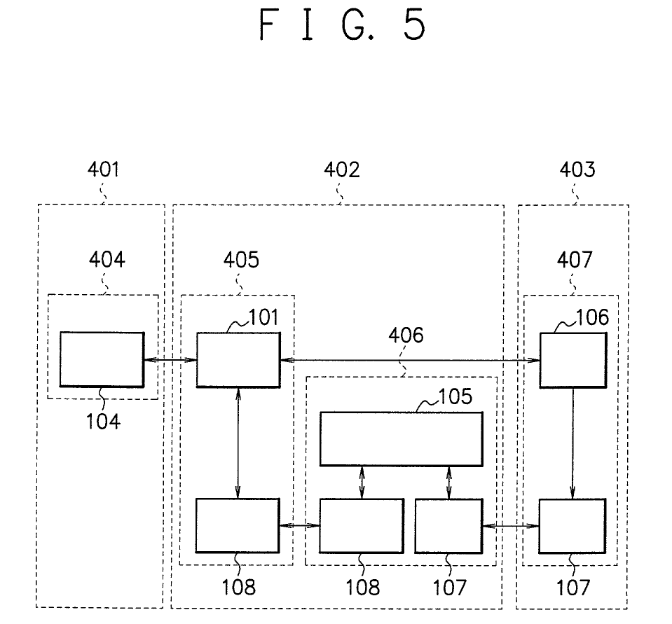

FIG. 5 shows a service providing system comprised of a user 401, a telecommunications carrier 402, and a service provider 403, each taking on part of the above functional components.

Incidentally, there is practically more than one user as well as service provider comprised in the system.

The user 401 has a computer 404 that is provided with the client 104. The computer 404 is connected to a communication network run by the telecommunications carrier 402 via a communication device 405 managed by the telecommunications carrier 402.

The telecommunications carrier 402 has the communication device 405 that is provided with the front-end management means 108 as well as implementing the front-end 101, and a computer 406 that is provided with the front-end management means 108 and service registration means 107, as well as managing service programs of the service provider 403 by the service management part 105. The communication device 405 communicates with the computer 404 belonging to the user 401 and a computer 407 belonging to the service provider 403 via the communication network. The computer 406 communicates with the communication device 405 and the computer 407 through the front-end management means 108 and service registration means 107, respectively.

Incidentally, the telecommunications carrier 402 practically manages more than one communication device.

The service provider 403 has the computer 407 that is provided with the server 106 for providing services to the user 401, and the service registration means 107 for registering service programs on the computer 406 belonging to the telecommunications carrier 402.

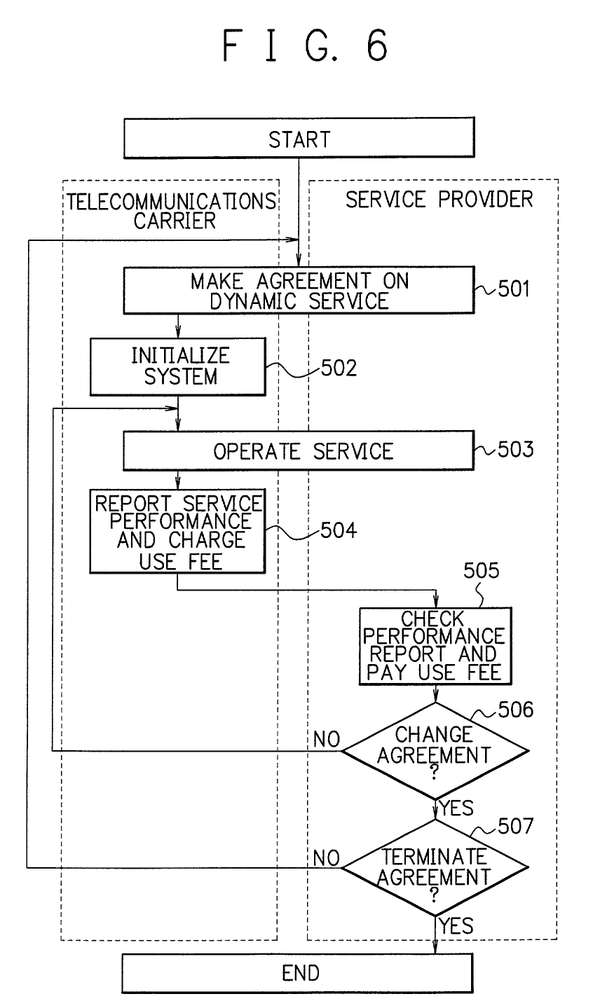

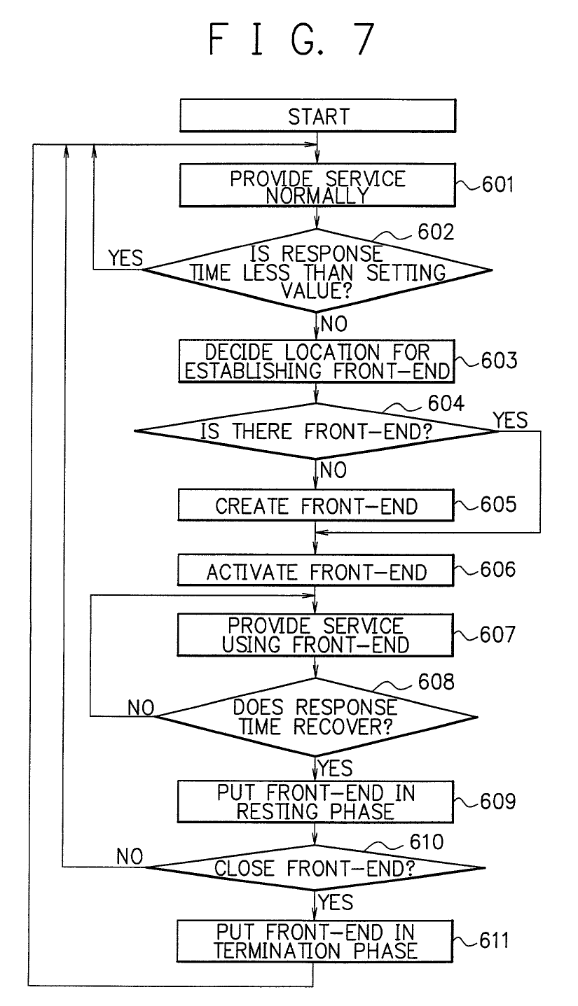

In the following, the operation of the service providing system shown in FIG. 5 will be explained with reference to FIGS. 6 and 7.

First, the telecommunications carrier 402 and service provider 403 make decision on service to which a front-end are applied, standards of front-end control, and conditions for resource consumption by the front-end. Then, as shown in FIG. 6, the telecommunications carrier 402 and service provider 403 make an agreement on the front-end-based dynamic service on the basis of the decision (step 501).

Next, the telecommunications carrier 402 and service provider 403 initialize the communication device 405 and computer 406 for the front-end-based dynamic service according to the agreement detail. More specifically, the service provider 403 registers a program of the service to be offered through the front-end on the service management part 105 by the service registration means 107. The telecommunications carrier 402 sets the standards of front-end control and conditions of resource consumption by the front-end on the service management part 105 (step 502).

After that, the operation of the front-end-based dynamic service starts (step 503).

During the front-end-based dynamic service, the telecommunications carrier 402 periodically reports the service performance of the front-end collected by the statistical information management function 304 to the service provider 403. Besides, the telecommunications carrier 402 charges the service provider 403 for a use fee calculated by the charging information management function 307 according to the service performance (step 504).

The service provider 403 checks the service performance report and use fee, and makes payment to the telecommunications carrier 402 (step 505).

Besides, the service provider 403 determines whether or not to amend the agreement detail based on the service performance report supplied from the telecommunications carrier 402. When no amendment is made, the operation returns to step 503 to carry on the front-end-based dynamic service (step 506, NO).

When the service provider 403 determines to amend the agreement detail, the operation returns to, provided that the agreement is not to be terminated, step 501, and restarts from making an agreement between the telecommunications carrier 402 and service provider 403 (step 507, NO).

If the agreement is to be terminated, the service provider 403 cancels the agreement, and closes the front-end-based dynamic service (step 507, YES).

In the following, a description will be given of the operation involved in the dynamic front-end control in the service operation (step 503 in FIG. 6).

Normally, front-end-based services offered to users are provided from the server 106, which is executed on the computer 407 managed by the service provider 403 (step 601).

When plural users access a service provided from the server 106, response time of the service is prolonged according to the number of users due to heavier loads on the network as well as the computer 407. The probe front-end 102, which is executed on the communication device 405, measures response time of the service accessed by the users. Accordingly, when the measured response time is less than a value specified in the agreement (setting value), the service is provided from the server 106 without using a front-end (step 602, YES).

On the other hand, when the measured value is equal to or more than the setting value, the location for establishing the service front-end 103 is determined by selecting a communication device, on which the probe front-end 102 has measured the response time (step 603).

If there is no service front-end 103 that provides the same service on the communication device, the service front-end 103 is created thereon (step 605).

If the service front-end 103 that provides the same service has been already created on the communication device, the service front-end 103 is activated (step 606).

The service front-end 103 in an active state performs processing activities of the server 106 by proxy for processing a part or all of the service tasks for the clients 104 (step 607).

While the service is delivered from the service front-end 103, the probe front-end 102 periodically measures service response time from the server 106 by making a pseudo service request to the server 106 to monitor busy condition of the server 106. The pseudo service request is made in a manner so as not to increase the loads on the server 106 and network.

As a result of the periodic check of the service response time, when the response time is equal to or more than the setting value, the use of the front-end 103 is continued for delivering the service to the users (step 608, NO).

When the measured response time recovers to below the setting value, the service front-end 103 is put in resting phase, and thereby the service using the front-end 103 is completed (step 609).

In the case of closing the service front-end 103 based on the agreement (step 610, YES), the service front-end 103 is put in termination phase and the service is provided normally from the server 106 (step 611).

When the service front-end 103 is not put in termination phase (step 610, NO), the service is provided from the server 106 while the service front-end 103 remains in resting phase.

As set forth hereinabove, in accordance with the present invention, response times of services offered by service providers can be kept at a certain length for all users who access the services.

Since response time of service is measured at a communication device that is an access point between a user and a communication network, and a front-end is established on the communication device when the measured response time is longer than standard response time preset by a telecommunications carrier and service provider, users who are provided with the service from the front-end can enjoy the service without suffering from the effects of loads on the network between the communication device and a server. Besides, the users who are provided with the service by the server can receive the service from the server whose processing speed has recovered from the heavy loads by delegating a part of service tasks to the front-end.

Moreover, according to the present invention, a quality of service can be maintained at a relatively low cost compared with the case where service providers prepare fixed additional servers.

Front-ends are created only when response time of service is equal to or more than a setting value, and unnecessary front-ends are terminated on the recovery of response time. Consequently, the amount of resources consumed by the front-ends changes dynamically, and telecommunications carriers charge service providers according to the utilization of resources.

Furthermore, it is possible to assure the safety of communication networks managed by telecommunications carriers as well as programs executed on computers and communication devices connected to the networks.

This is because service programs executed as front-ends are proven to be safe at the time of making an agreement between a telecommunications carrier and service provider, and managed by a service performance monitoring unit, which issues front-end control instructions, operated by the telecommunications carrier.

Furthermore, front-ends executed on communication devices can be used without amending client software.

This is because when service request from a client to a server goes through the communication device, the communication device identifies the service request and switches its destination from the server to its own front-end.

While the preferred embodiment of the present invention have been described using specific terms, such description is for illustrative purposes only, and it is to be understood that changes and variations may be made without departing from the spirit or the scope of the following claims.

What is claimed is:

1. A service providing system using front-ends comprising:
a server for processing service tasks in response to service request from a client, and delivering service to the client;
a means for measuring service response time from when the client requests the server for service to when the server delivers the service to the client;
a means for judging whether or not the service response time is equal to or more than a setting value;
a means for creating a front-end to process the service tasks of the server and perform the service delivery in whole or in part when the service response time is equal to or more than the setting value; and
a means for having the front-end process the service tasks and perform the service delivery in whole or in part as proxy for the server.

2. The service providing system using front-ends claimed in claim 1, further comprising a means for bringing the front-end to rest when the response time recovers to less than the setting value after the front-end has processed the service tasks and performed the service delivery in whole or in part as proxy for the server.

3. The service providing system using front-ends claimed in claim 1, further comprising a means for charging a service provider according to the volume of traffic between the client and front-end, and/or the amount of computer resources consumed by the front-end.

4. The service providing system using front-ends claimed in claim 1, wherein the front-end is created on a communication device.

5. A service providing method using front-ends comprising the steps of:
measuring service response time from when a client requests a server for service to when the server delivers the service to the client;
judging whether or not the service response time is equal to or more than a setting value;
creating a front-end to process the service tasks of the server and perform the service delivery in whole or in part when the service response time is equal to or more than the setting value; and
having the front-end process the service tasks and perform the service delivery in whole or in part as proxy for the server.

6. The service providing method using front-ends claimed in claim 5, further comprising the step of bringing the front-end to rest when the response time recovers to less than the setting value after the front-end has processed the service tasks and performed the service delivery in whole or in part as proxy for the server.

7. The service providing method using front-ends claimed in claim 5, further comprising the step of charging a service provider according to the volume of traffic between the client and front-end, and/or the amount of computer resources consumed by the front-end.

8. The service providing method using front-ends claimed in claim 5, wherein the front-end is created on a communication device.
